(19) United States
(12) Patent Application Publication
(10) Pub. No.: US 2011/0061698 A1
(43) Pub. Date: Mar. 17, 2011

(54) ELECTRIC TELESCOPIC STICK

(75) Inventor: Katsumi Iwata, Hashima-shi (JP)

(73) Assignee: IWATA TEKKOSHO CO., LTD., Hashima-shi (JP)

(21) Appl. No.: 12/795,039

(22) Filed: Jun. 7, 2010

(30) Foreign Application Priority Data
Sep. 16, 2009 (JP) 2009-214208

(51) Int. Cl. A45B 9/00; H02K 7/14

(52) U.S. Cl. 135/69; 310/50

(57) ABSTRACT

There is provided an electric telescopic stick of which length can be easily adjusted quickly if needed by using only one hand by providing a multiple thread screw and providing a switch on an anterior portion of a grip portion including an electric motor which rotates the multiple thread screw in the forward and reverse directions. Further, in the electric telescopic stick, since a clutch is formed between the electric motor and the multiple thread screw, overload is not applied to the motor because the clutch idles when the movable stick portion is completely elongated. Further, a user can recognize the idling state from hitting sounds generated when steel balls are hit against holes when the clutch idles.

The present application is based on Japanese Priority Application No. 2009-214208 filed on Sep. 16, 2009 with the Japan Patent Office, the entire contents of which are hereby incorporated by reference.

### BACKGROUND OF THE INVENTION

1. Field of the Invention

The present invention relates to an electric telescopic stick having a telescopic function for assisting a user in going up and down stairs, and in standing up from a chair or the like and sitting down, or the like.

2. Description of the Related Art

An existing stick has simply a bar shape. Further, there are a telescopic stick which is fixed by fitting a bush button into a hole and a telescopic stick which is fixed by tightly screwing. However, these sticks cannot instantaneously respond to a user's operation because these sticks elongate and contract every time the user stands up from a chair or the like, the user goes up and down stairs, or the like.

On the other hand, sticks having an electric telescopic function have been disclosed in Japanese Patent Application Laid-open Nos. 7-246223, 8-242917, 2002-35064, and 2005-6699 and Japanese Utility Model No. 3133880. However, a multiple thread screw is not used in any of these disclosed techniques for converting a rotation motion to a linear motion. Therefore, the sticks less quickly elongate and contract in response to operations.

### SUMMARY OF THE INVENTION

The present invention has been made in consideration of the above-described disadvantages and an object of the invention is to provide a stick having a telescopic function capable of quickly elongating and contracting so as to assist a user in going up and down stairs, in standing up from a chair or the like and sitting down, or the like by using only one hand.

In order to achieve the above object, according to an aspect of the invention, there is provided an electric telescopic stick including a grip portion having a motor accommodation portion, a fixed stick portion which is fixed to a lower portion of the grip portion and has a hollow portion inside, a movable stick portion which is supported in the hollow portion of the fixed stick portion in a slidable manner in the vertical direction, a multiple thread screw of which upper end is rotatably supported in the hollow portion of the fixed stick portion and of which lower portion is engaged with a nut member fixed to an upper portion of the movable stick portion, an electric motor which rotates the multiple thread screw in the forward and reverse directions, and a clutch which idles when an overload is applied to the electric motor.

A battery for driving the electric motor is accommodated in the grip portion. Further, a buttery accommodation portion together with an electric circuit substrate may be provided on an outer side of the fixed stick portion. This increases the degree of design freedom of a configuration in the grip portion.

The stick is elongated and contracted by rotating the electric motor in the forward and reverse directions or stopping the electric motor with a switch provided on the grip portion. At this time, a reduction gear is used for changing directions of rotational axes between the grip portion and the fixed stick portion in order to make the speed of elongation and contraction appropriate. If a worm gear is used as the reduction gear, the rotational axes are deviated from each other and the grip portion and the fixed stick portion are not connected to each other straightly. However, if a crown gear is used as the reduction gear, the rotational axes of the grip portion and the fixed stick portion can be located on a flat surface.

If the grip portion and the fixed stick portion are formed into a prismatic shape, a nut member which engages with the rotating the multiple thread screw can be prevented from rotating. However, the grip portion and the fixed stick portion are formed with extrusion pipes provided with protrusions at the inner portion of the hollow pipe.

A space is provided between the fixed stick portion and the movable stick portion in order to make the movable stick portion slidable. Each slidable side of the fixed stick portion and the movable stick portion is subjected to friction reduction coating such as Teflon (registered trademark) coating so that the space between the fixed stick portion and the movable stick portion can be small to minimum. Therefore, rocks, sands, dusts, or the like can be prevented from being caught by the space.

The grip portion may be formed with or coated with an elastic material. If the surface of the grip portion has an elastic property, the stick is not easily slipped when set against the wall. Further, if an entire surface of the grip portion including the switch is coated with an elastic material, water is not entered so as to protect an electric system. As the elastic material, elastic coating materials such as latex and emulsion in addition to rubber, urethane and thermal plastic elastomer can be selected.

Further, in the multiple thread screw according to the aspect of the invention, a ratio of a thread pitch with respect to a circumference is 0.04 or more and lower than 0.1.

Normally, when a screw is turned one revolution, the movable stick portion elongates or contracts by one thread. When the multiple thread screw is turned one revolution, the movable stick portion elongates or contracts for multiple threads. Therefore, the movable stick portion elongates or contracts faster. However, as the number of threads in the multiple thread screw is larger, the screw is turned by pushing a nut into the fixed stick portion when a load is applied at the time of use. This causes the stick to be contracted so that the stick is unable to support a user against the user's weight. In the aspect of the invention, the screw is prevented from reversely rotating by setting a ratio P/L of a length P of the pitch moving when the screw is turned one revolution with respect to a circumference L of the screw to 0.04 or more and lower than 0.1.

In the aspect of the invention, a clutch is formed between the electric motor and the multiple thread screw operates only when the stick is elongated. Further, the clutch includes springs and balls which are accommodated in deep holes provided on one end of a rotational axis and two abutment holes which are provided on a surface of a connecting axis at a position opposite to the deep holes. Each of the two abutment holes is formed such that the hole becomes gradually shallower in the circumferential direction from a center position while keeping a depth so as to hold the ball. The rotational axes are connected to each other in a state where the balls are pressed against the abutment holes by forces of the springs during normal rotation. On the other hand, the balls are forcedly put into the deep holes against forces of the springs so that the rotational axes are released from each other and the clutch idles under overload condition.

According to the invention, an electric telescopic stick is composed of a multiple thread screw and an electric motor which rotates the multiple thread screw in the forward and reverse directions. Therefore, the stick can be elongated and contracted quickly if needed.

Further, since a clutch is formed between an electric motor and a multiple thread screw, overload is not applied to the electric motor because the clutch idles when the movable stick portion is completely elongated. Further, a user can recognize the idling state from hitting sounds generated when balls are hit against holes when the clutch idles.

### BRIEF DESCRIPTION OF THE DRAWINGS

FIG. 1 is an entire view according to a best mode for executing the invention.

FIG. 2 is an operation explanation view according to the best mode for executing the invention.

FIG. 3 is a cross-sectional view illustrating a clutch.

### DESCRIPTION OF THE EMBODIMENTS

Hereinafter, embodiments of the invention will be described with reference to drawings.

### First Embodiment

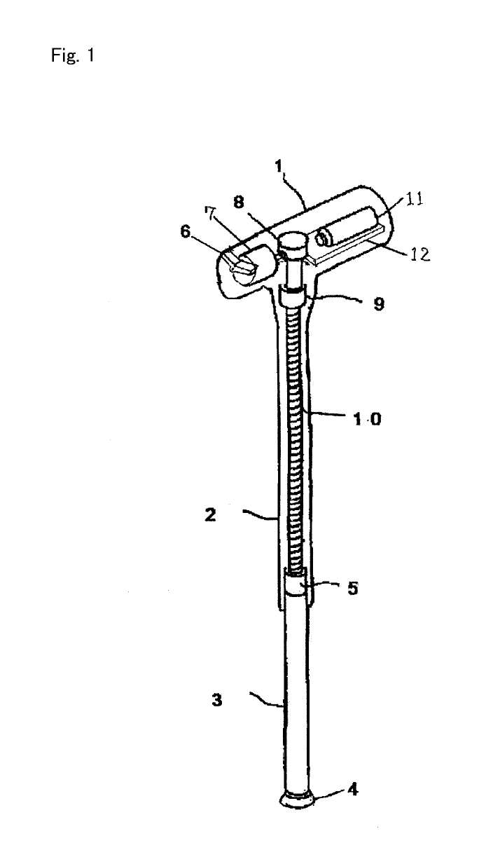

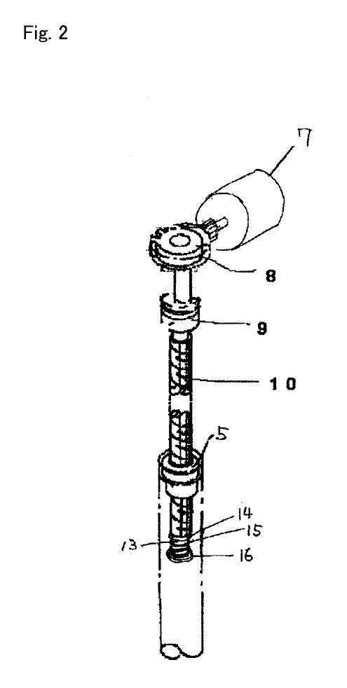

In FIG. 1 and FIG. 2, a fixed stick portion 2 and a movable stick portion 3 are formed with a hollow outer pipe and a hollow inner pipe, respectively. The fixed stick portion 2 and the movable stick portion 3 constitute a stick main body and are made of a lightweight metal material such as carbon pipe and duralumin having high flexural strength. Further, a grip portion 1 is attached to an upper portion of the fixed stick portion 2.

An electric motor 7, a control circuit substrate 12 for driving the motor, a lithium-ion rechargeable battery 11 and a switch 6 are built in the grip portion 1. The electric motor 7 is rotation-driven in the forward and reverse directions by operating the switch 6 in the grip portion 1. It is to be noted that an outer surface of the grip portion 1 is coated with flexible synthetic rubber or foamable resin flexible member.

The stick main body is composed of the fixed stick portion 2 having a large diameter and the movable stick portion 3 which is fitted into the fixed stick portion 2 by insertion in a slidable manner in the axial line direction. The fixed stick portion 2 and the movable stick portion 3 are formed into a pipe shape or a prismatic shape. In a case where the fixed stick portion 2 and the movable stick portion 3 are formed into the prismatic shape, the movable stick portion 3 can be prevented from rotating when the movable stick portion 3 is fitted into the fixed stick portion 2 by insertion. However, in a case where the fixed stick portion 2 and the movable stick portion 3 are formed into the pipe shape, a protruded stripe and a recessed stripe are formed as follows. That is, a protruded stripe projecting and extending in the axial line direction is formed on an inner circumferential surface of the fixed stick portion 2 and a recessed stripe which can engage with the above protruded stripe are formed on an outer circumferential surface of the movable stick portion 3. With the protruded stripe and the recessed stripe, the fixed stick portion 2 and the movable stick portion 3 are engaged with each other so that the movable stick portion 3 is prevented from rotating in a state where the movable stick portion 3 is movable in the axial line direction. Further, as means for preventing the movable stick portion 3 fitted into a hollow portion of the fixed stick portion 2 by insertion from rotating, cross sections of the fixed stick portion 2 and the movable stick portion 3 in the direction orthogonal to the axial line may be formed into an elliptical shape.

A nut member 5 is fixed to the upper end of the movable stick portion 3 by fitting into the movable stick portion 3 by insertion. Further, one end of the multiple thread screw 10 is supported by the grip portion 1 attached to the fixed stick portion 2 with a bearing in a state where the multiple thread screw 10 is rotatable and is prevented from slipping out. The other end of the multiple thread screw 10 is engaged with the nut member 5.

A crown gear set 8 is attached to an axial end of the multiple thread screw 10 supported by the grip portion 1 through a clutch 9. Further, the crown gear set 8 is engaged with a pinion gear attached to a rotational axis of the electric motor 7. With this configuration, the multiple thread screw 10 is rotated in the forward and reverse directions in accompanied with the driving of the electric motor 7.

### Second Embodiment

A buffer device composed of a slide metal member 13, a spring holder 14, a spring 15 and a sleeve 16 is built in a lower end of the multiple thread screw 10 as shown in FIG. 2. With the buffer device, the nut member 5 hits against the spring holder 14 when the stick is elongated to the maximum and the spring holder 14 is compressed by the spring 15. However, the clutch operates before the spring completely contracts so that biting of threads can be eliminated. From this state, the stick can be contracted without any difficulty by reversely rotating the multiple thread screw 10 by the switch 6.

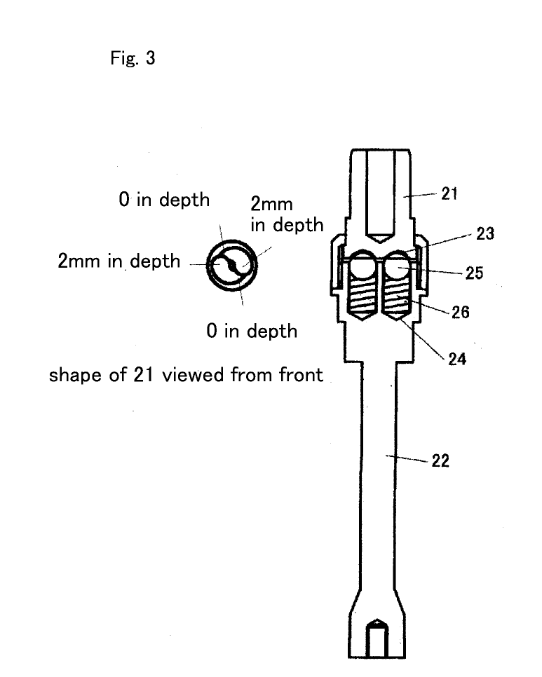

In FIG. 3, an example of the clutch used in the invention is illustrated. The clutch operates only when the stick is elongated. Further, the clutch includes springs 26 and steel balls 25 which are accommodated in deep holes 24 and two abutment holes 23 which are provided on a surface of a multiple thread screw connecting axis 21 at a position opposite to the deep holes 24. At this time, the deep holes 24 are provided on one end of a rotational axis 22. Each of the two abutment holes 23 is formed such that the hole becomes gradually shallower in the circumferential direction from a center position while keeping a depth so as to hold the steel ball 25. The rotational axes are connected to each other in a state where the balls are pressed against the abutment holes by forces of the springs during normal rotation. On the other hand, the steel balls 25 are forcedly put into the deep holes 24 against forces of the springs 26 so that the rotational axes are released from each other and the clutch idles under overload condition.

The invention is used in the nursing care field for assisting actions of elderly people and people with disabilities.

What is claimed is:

1. A electric telescopic stick comprising:
a grip portion having a motor accommodation portion;
a fixed stick portion which is fixed to a lower portion of the grip portion and has a hollow portion inside;
a movable stick portion which is supported in the hollow portion of the fixed stick portion in a slidable manner in the vertical direction;
a multiple thread screw of which upper end is rotatably supported in the hollow portion of the fixed stick portion and of which lower portion is engaged with a nut member fixed to an upper portion of the movable stick portion;
an electric motor which rotates the multiple thread screw in the forward and reverse directions; and
a clutch which idles when an overload is applied to the electric motor.

2. The electric telescopic stick according to claim 1,
wherein a ratio P/L of a length P moving when the multiple thread screw is turned one revolution with respect to a circumference L of the screw is 0.04 or more and lower than 0.1.

3. The electric telescopic stick according to claim 1,
wherein the fixed stick portion is formed with a carbon pipe.

4. The electric telescopic stick according to claim 1,
wherein axes of the grip portion and the fixed stick portion are connected to each other with a crown gear in a reduction gear of the electric motor.

5. The electric telescopic stick according to claim 1,
wherein the movable stick portion is prevented from rotating in a state where the movable stick portion is movable in the axial line direction by forming a protruded stripe projecting and extending in the axial line direction on an inner circumferential surface of the fixed stick portion and forming a recessed stripe which can engage with the protruded stripe on an outer circumferential surface of the movable stick portion, and engaging the fixed stick portion and the movable stick portion with each other with the protruded stripe and the recessed stripe.

6. The electric telescopic stick according to claim 1,
wherein the electric motor, a reduction gear, a switch which rotates the electric motor in the forward and reverse directions, a control circuit substrate and a lithium-ion rechargeable battery are accommodated in the grip portion.

7. The electric telescopic stick according to claim 1,
wherein a switch which rotates the electric motor in the forward and reverse directions is provided on an anterior portion of the grip portion.

8. The electric telescopic stick according to claim 1,
wherein a buffer device composed of a slide metal member, a spring holder, a spring, a sleeve is provided on a lower end of the multiple thread screw.
